(19) United States
(12) Patent Application Publication
(10) Pub. No.: US 2014/0094064 A1
(43) Pub. Date: Apr. 3, 2014

(54) CARD CONNECTOR STRUCTURE

(71) Applicant: ADVANCED-CONNECTEK INC., Taipei (TW)

(72) Inventors: Yu-Lun TSAI, Taipei (TW); Pin-Yuan HOU, Taipei (TW); Kou-Ching LEE, Taipei (TW)

(21) Appl. No.: 14/043,318

(22) Filed: Oct. 1, 2013

(30) Foreign Application Priority Data
Oct. 1, 2012 (TW) 101218957

(51) Int. Cl. H01R 13/6473

(52) U.S. Cl. CPC H01R 13/6473
USPC 439/630

(57) ABSTRACT

A card connector structure is provided. A card connector includes an insulating seat body, a plurality of insulating main bodies, a plurality of first terminal sets and a plurality of second terminal sets. The insulating seat body includes a card slot for accommodating a preset electronic card; the plurality of insulating main bodies is arranged in the insulating seat body, and include two terminal slots; and the plurality of first terminal sets and the plurality of second terminal sets are respectively staggered in the two terminal slots of the insulating main bodies; the first terminal set and the second terminal set have a first contact point and a second contact point respectively, for contacting the electronic card; and the first contact point is higher than the second contact point. Through the structure, the present creation can avoid high-frequency electrical impedance, so as to make the card connector more stable.

### CROSS-REFERENCES TO RELATED APPLICATIONS

This non-provisional application claims priority under 35 U.S.C. §119(a) on Patent Application No. 101218957 filed in Taiwan, R.O.C. on 2012 Oct. 1, the entire contents of which are hereby incorporated by reference.

### BACKGROUND

1. Technical Field

The present creation relates to a card connector structure, and more particularly to a card connector structure that can avoid high-frequency electrical impedance, so as to make the card connector more stable.

2. Related Art

As technologies advance, a variety of electronic devices flood in our daily life, and in order to enable the electronic devices to achieve the effect of transmitting signals, various connectors have become essential components.

A card connector is widely applied to the motherboard of personal computers, for connecting various electronic cards such as display cards, sound cards or network cards to achieve specific functions, and the card connector includes: an insulating seat body, a plurality of insulating main bodies and a plurality of terminal sets. The insulating seat body includes a card slot for accommodating a preset electronic card; the plurality of insulating main bodies is arranged in the insulating seat body, and includes a terminal slot; and the plurality of terminal sets is disposed in the terminal slot of the insulating main bodies.

Through the structure, users can connect an electronic card to a card slot of the insulating seat body, and connect to a connecting end (commonly known as goldfinger) of the electronic card through the plurality of terminals, and in this way, connection of the electronic card is completed.

However, the card connector still has the following problems to be solved:

Firstly, as the current transmission speed of electronic signals has reached more than hundreds of MHz, the quality of signal transmission is very important in such a high transmission speed, and in order to obtain the optimal signal transmission quality, special attention should be paid to various high-frequency parameters, for example, impedance, noise, lose, attenuation and other problems. However, when the card connector is connected, capacitance is generated once two conductors are close to each other, and in the high-frequency environment, impedance reduction caused by such a capacitance effect cannot be ignored. Therefore, signals may not be distorted only when impedance matching is performed, but the existing card connector has the problem of high-frequency electrical impedance matching.

Secondly, the insulating main bodies of the existing card connector are individually assembled on the insulating seat body, the insulating main bodies are likely to break or have insufficient strength when assembled, and, all the insulating main bodies must be assembled manually, which has a low production capacity, and it is difficult to ensure the quality.

Thirdly, terminals of the existing card connector have small sizes, and with the elasticity of the terminals, it is difficult to ensure the plug force when the electronic card is inserted.

Fourthly, the insulating seat body of the existing card connector has insufficient strength, and low durability.

Therefore, how to solve the above conventional problems and defects is the direction in which inventors of the present creation and relevant manufacturers in the industry are anxious to research and improve.

### SUMMARY

Hence, the inventors of the present creation, in view of the above defects, design this utility model patent by collecting related information, through evaluation and consideration by multiple parties, according to accumulated years of experience in engagement in the industry, and through constant attempts and modifications.

A main objective of the present utility model is to provide a card connector structure that can avoid high-frequency electrical impedance, so as to make the card connector more stable.

To achieve the above objective, the present creation provides a card connector structure, where a card connector at least includes:

an insulating seat body, including a card slot for accommodating a preset electronic card;

a plurality of insulating main bodies arranged in the insulating seat body, and including two terminal slots; and

a plurality of first terminal sets and a plurality of second terminal sets, respectively staggered in the two terminal slots of the insulating main bodies, where the first terminal set and the second terminal set have a first contact point and a second contact point respectively, for contacting the electronic card, and the first contact point is higher than the second contact point.

In a preferred embodiment, at least one side of the insulating main body includes a bump, at least one corresponding side of another insulating main body includes a gap, and the insulating main bodies are combined with each other by engaging the bumps with the gaps.

In a preferred embodiment, the first terminal set includes two opposite first terminals, the two first terminals each include a first root portion, the two first root portions have a first spacing therebetween, the second terminal set includes two opposite second terminals, the two second terminals each include a second root portion, the two second root portions have a second spacing therebetween, and the second spacing is greater than the first spacing.

In a preferred embodiment, the bottom of the insulating main bodies is provided with a plurality of ribs.

In a preferred embodiment, the electronic card is a display card.

The first terminal sets and the second terminal sets are respectively staggered in the two terminal slots of the insulating main bodies, and the first contact point of the first terminal set is higher than the second contact point of the second terminal set. An effective breakthrough is achieved regarding the problem of high-frequency electrical impedance matching existing in the prior art. The present creation, through the designs that the first terminal sets and the second terminals sets are staggered and the first contact point and the second contact point are set to have different heights, can avoid high-frequency electrical impedance, so as to make the card connector more stable.

The insulating main bodies in the present creation can be combined with each other by engaging the bumps with the gaps. Therefore, an effective breakthrough is achieved regarding the problems existing in the prior art that the insulating main bodies are likely to break or have insufficient strength, a production capacity is low, and it is difficult to ensure the quality. In the present creation, the insulating main bodies combined with each other by stacking can avoid rupture and have improved strength, and meanwhile through mechanical automatic mass assembly, a higher production capacity is achieved, and the quality can be ensured.

The second spacing of the second terminal sets of the present creation is greater than the first spacing of the first terminal sets, and the first terminal sets and the second terminal sets are respectively staggered in the two terminal slots of the insulating main bodies. Thus, an effective breakthrough is achieved regarding the problem existing in the prior art that it is difficult to ensure the plug force when the electronic card is inserted. The present creation obtains two-stage different flexibilities with the first terminal sets and the second terminal sets having different spacings, to further improve the plug force when the electronic card is inserted.

In addition, the bottom of the insulating seat body of the present creation is provided with a plurality of ribs. Thus, an effective breakthrough is achieved regarding the problems existing in the prior art that structural strength is insufficient and durability is low.

The present creation, through the setting of the ribs, effectively enhances the structural strength of the card connector, and improves the durability.

### BRIEF DESCRIPTION OF THE DRAWINGS

The present creation will become more fully understood from the detailed description given herein below for illustration only, and thus are not limitative of the present creation, and wherein:

FIG. 1 is a three-dimensional view I of a preferred embodiment of the present creation, showing three-dimensional appearance of a card connector according to the present creation;

FIG. 2 is a three-dimensional view II of a preferred embodiment of the present creation, showing three-dimensional appearance of the card connector in another angle according to the present creation;

FIG. 3 is a sectional view I of a preferred embodiment of the present creation, showing first terminal sets of the card connector according to the present creation;

FIG. 4 is a sectional view II of a preferred embodiment of the present creation, showing second terminal sets of the card connector according to the present creation;

FIG. 5 is a schematic partial view I of a preferred embodiment of the present creation, showing that at least one side of an insulating main body of the card connector according to the present creation includes a bump, and at least one corresponding side of another insulating main body includes a gap; and

FIG. 6 is a schematic partial view II of a preferred embodiment of the present creation, showing that the insulating main bodies of the card connector according to the present creation combine with each other.

### DETAILED DESCRIPTION

To achieve the objectives and effects, and facilitate full understanding of the technical means and construction used in the present creation, the features and functions are described below in detail with reference to the accompanying drawings and preferred embodiments of the present creation.

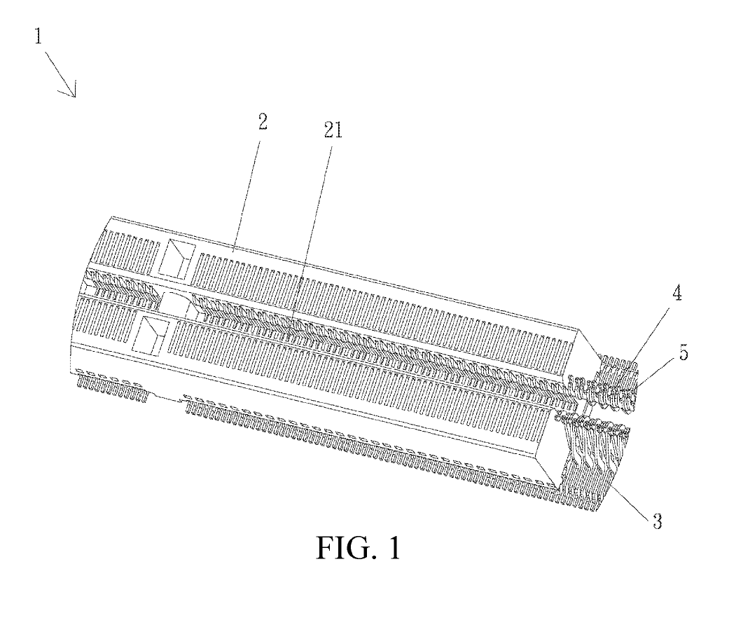

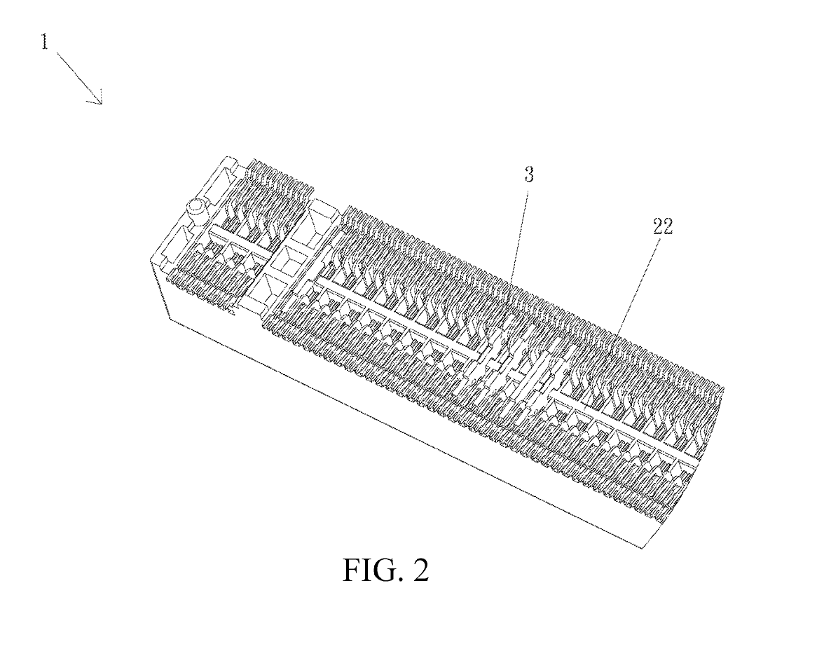

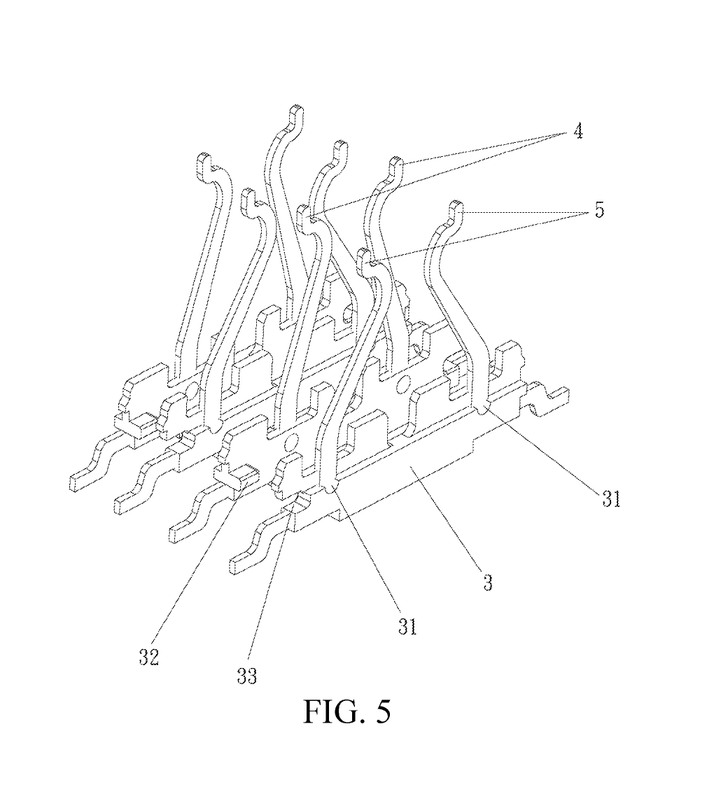

Referring to FIG. 1, FIG. 2 and FIG. 5, FIG. 1 is a three-dimensional view I of a preferred embodiment of the present creation, FIG. 2 is a three-dimensional view II of a preferred embodiment of the present creation, and FIG. 5 is a schematic partial view I of a preferred embodiment of the present creation. It can be seen clearly from the drawings that, the present creation relates to a structure of a card connector 1, and the card connector 1 at least includes: an insulating seat body 2, a plurality of insulating main bodies 3, a plurality of first terminal sets 4 and a plurality of second terminal sets 5.

The insulating seat body 2 includes a card slot 21 for accommodating a preset electronic card (not shown), and in this embodiment, the bottom of the insulating seat body 2 is provided with a plurality of ribs 22, and the electronic card is a display card.

The plurality of insulating main bodies 3 is arranged in the insulating seat body 2, and includes two terminal slots 31.

The plurality of first terminal sets 4 and the plurality of second terminal sets 5 are respectively staggered in the two terminal slots 31 of the insulating main bodies 3.

As, in the present creation, the bottom of the insulating seat body 2 is provided with a plurality of ribs 22, such a structure effectively enhances structural strength of the card connector 1, and improves durability.

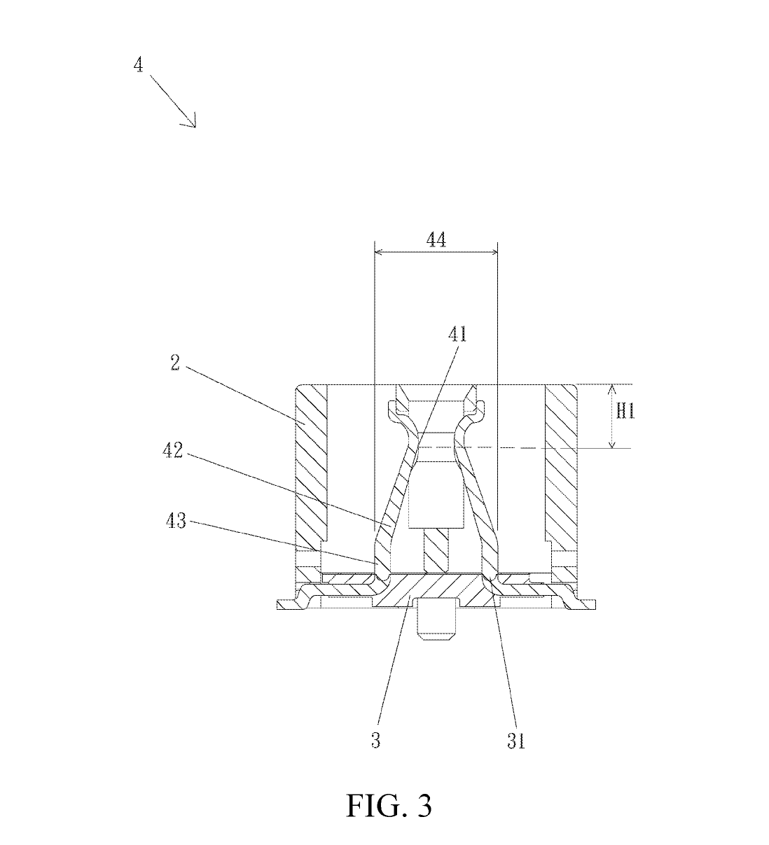

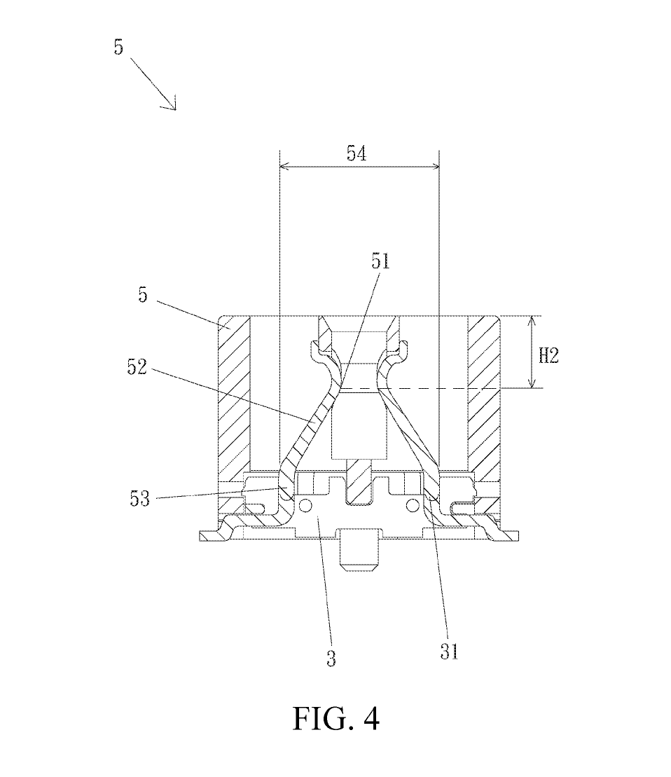

Referring to FIG. 3, FIG. 4 and FIG. 5 at the same time, FIG. 3 is a sectional view I of a preferred embodiment of the present creation, FIG. 4 is a sectional view II of a preferred embodiment of the present creation, and FIG. 5 is a schematic partial view I of a preferred embodiment of the present creation. As shown in FIG. 3 and FIG. 4, in the present creation, the first terminal set 4 and the second terminal set 5 have a first contact point 41 and a second contact point 51 respectively, for contacting the electronic card, and the first contact point 41 is higher than the second contact point 51. In this embodiment, a distance from the first contact point 41 to a top edge of the insulating seat body 2 is H1, a distance from the second contact point 51 to the top edge of the insulating seat body 2 is H2, and H1<H2; therefore, the first contact point 41 is higher than the second contact point 51. Besides, as shown in FIG. 5, it can be seen clearly that the first terminal sets 4 and the second terminal sets 5 are respectively staggered in the two terminal slots 31 of the insulating main bodies 3.

The present creation, through the designs that the first terminal sets 4 and the second terminals sets 5 are staggered and the first contact point 41 is higher than the second contact point 51, can avoid high-frequency electrical impedance, so as to make the card connector more stable.

Moreover, as shown in FIG. 3 and FIG. 4, it can be seen clearly that the first terminal set 4 includes two opposite first terminals 42, the two first terminals 42 each include a first root portion 43, the two first root portions 43 have a first spacing 44 therebetween, and the second terminal set 5 includes two opposite second terminals 52, the two second terminals 52 each include a second root portion 53, the two second root portions 53 have a second spacing 54 therebetween, and the second spacing 54 is greater than the first spacing 44.

The present creation obtains two-stage different flexibilities with the first terminal sets 4 and the second terminal sets 5 having different spacings and the first terminal sets 4 and the second terminal sets 5 staggered in the two terminal slots 31 of the insulating main bodies 3, to further improve the plug force when the electronic card is inserted.

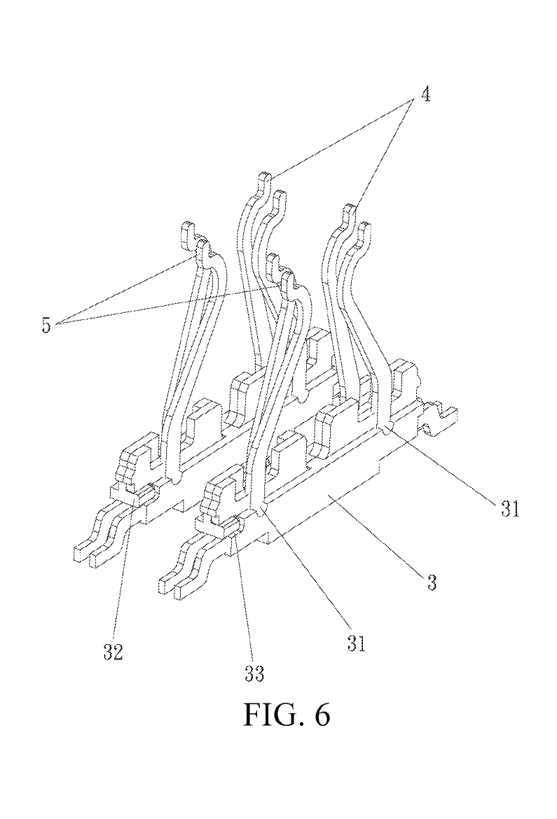

Referring to FIG. 5 and FIG. 6 at the same time, FIG. 5 is a schematic partial view I of a preferred embodiment of the present creation, and FIG. 6 is a schematic partial view II of a preferred embodiment of the present creation. It can be seen clearly from the drawings that, at least one side of the insulating main body 3 includes a bump 32, at least one corresponding side of another insulating main body 3 includes a gap 33, and the insulating main bodies 3 are combined with each other by engaging the bumps 32 with the gaps 33.

With the structure, in the present creation, the insulating main bodies 3 are combined with each other by stacking, so that during assembling of the insulating main bodies 3, rupture can be avoided and strength is improved, and meanwhile through mechanical automatic mass assembly, a higher production capacity is achieved, and the quality can be ensured.

Referring to all the drawings, compared with the conventional technology, the present creation has the following advantages:

Firstly, it can avoid high-frequency electrical impedance, to make the card connector 1 more stable.

Secondly, it can avoid rupture of the insulating main bodies 3 and improve strength, and meanwhile through mechanical automatic mass assembly, it has a higher production capacity, and the quality can be ensured.

Thirdly, it improves the plug force when the electronic card is inserted.

Fourthly, it enhances the structural strength of the card connector 1, and improves durability.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A card connector structure, wherein a card connector at least comprises:
an insulating seat body, comprising a card slot for accommodating a preset electronic card;
a plurality of insulating main bodies arranged in the insulating seat body, and comprising two terminal slots; and
a plurality of first terminal sets and a plurality of second terminal sets, respectively staggered in the two terminal slots of the insulating main bodies, wherein the first terminal set and the second terminal set have a first contact point and a second contact point respectively, for contacting the electronic card, and the first contact point is higher than the second contact point.

2. The card connector structure according to claim 1, wherein at least one side of the insulating main body comprises a bump, at least one corresponding side of another insulating main body comprises a gap, and the insulating main bodies are combined with each other by engaging the bumps with the gaps.

3. The card connector structure according to claim 1, wherein the first terminal set comprises two opposite first terminals, the two first terminals each comprise a first root portion, the two first root portions have a first spacing therebetween, the second terminal set comprises two opposite second terminals, the two second terminals each comprise a second root portion, the two second root portions have a second spacing therebetween, and the second spacing is greater than the first spacing.

4. The card connector structure according to claim 1, wherein the bottom of the insulating main bodies is provided with a plurality of ribs.

5. The card connector structure according to claim 1, wherein the electronic card is a display card.
